(19) United States
(12) Patent Application Publication
(10) Pub. No.: US 2013/0005414 A1
(43) Pub. Date: Jan. 3, 2013

(54) MULTI-PURPOSE INTELLIGENT CRADLE FOR A VEHICLE

(76) Inventors: Gurbrinder Singh Bindra, Bangalore (IN); Ajith Kumar Padmalayam Narayana Kurup, Bangalore (IN); Shanmugasundaram Murugesan, Bangalore (IN); Asit Mishra, Bangalore (IN)

(21) Appl. No.: 13/634,411

(22) PCT Filed: Mar. 14, 2011
(86) PCT No.: PCT/IN11/00171

§ 371 Date: Sep. 12, 2012

(30) Foreign Application Priority Data
Mar. 12, 2010 (IN) 662/CHE/2010

(51) Int. Cl. H04M 1/00

(52) U.S. Cl. 455/575.9

(57) ABSTRACT

The present invention provides a mobile device cradle for a vehicle. The cradle may include docking members for receiving a mobile device of a driver of the vehicle. The cradle may also include a face recognition means for periodically capturing a face of the driver, environmental conditions, and traffic conditions. Further, the cradle may include an authentication unit for authenticating the mobile device and the face of the driver captured by the face recognition means and for providing an authentication signal for starting the vehicle to an electronic engine control unit (EECU). Furthermore, the cradle may include an information collection unit for collecting dynamic information associated with the driver and the vehicle from monitoring units. Moreover, the cradle may also include a communication unit for communicating the dynamic information to back office system(s) communicatively coupled to the mobile device via a wireless communication network.

### RELATED APPLICATION

Benefit is claimed to India Provisional Application No. 662/CHE/2010, entitled “MULTIPURPOSE INTELLIGENT CRADLE AND METHOD THEREOF” by G. B. S. Bindra, et Al., filed on Mar. 12, 2010, which is herein incorporated in its entirety by reference for all purposes.

### FIELD OF THE INVENTION

The present invention relates to vehicle accessories, and more particularly relates to a mobile device cradle for a vehicle.

### BACKGROUND OF THE INVENTION

Today, intelligent monitoring and communication system plays a vital role, as there is a requirement for capturing various parameters related to an appliance such as vehicle and transmitting such parameters to back office systems over communication medium for further processing. In the intelligent transportation system, measuring various parameters related to the vehicle is required for intelligently taking various actions on the vehicle.

Conventionally, the automobile manufacturers provide the facility in the vehicles to monitor the conditions of the vehicle without human intervention based on standards such as On Board Diagnostics (OBD). The OBD units provide access to state of health information for various vehicle sub systems. Further, getting various parameters from OBD units and transferring the values to a back office system requires additional devices within the vehicle. This adds additional cost to the vehicle owner's or those who are interested to get said values in the back office for further processing. The major costs here are due to various on board equipments that need to be fitted within the vehicle for capturing different parameters and the cost for communication from each of these devices, particularly wireless communication such as SMS, GPRS etc.

Therefore, from the foregoing, there exists a need for an intelligent single equipment to capture various parameters from entities, both internal and external to the vehicle and communicate the same to a back office system.

### SUMMARY OF THE INVENTION

The present invention provides a multi-purpose intelligent cradle for a vehicle. In one aspect, the cradle includes docking members for receiving a mobile device of a driver of the vehicle. The cradle also includes a face recognition means for periodically capturing the face of the driver, environmental conditions, and traffic conditions. Further, the cradle includes an authentication unit for authenticating the mobile device and the face of the driver captured by the face recognition means and for providing an authentication signal for starting the vehicle to an electronic engine control unit (EECU).

Furthermore, the cradle includes an information collection unit for collecting dynamic information associated with the driver and the vehicle from monitoring units. Moreover, the cradle also includes a communication unit for communicating the dynamic information to back office system(s) communicatively coupled to the mobile device via a wireless communication network.

In another aspect, a system includes a mobile device of a driver of a vehicle, and monitoring units for monitoring dynamic information associated with at least one of the driver and the vehicle. The system further includes a mobile device cradle coupled to the monitoring units for collecting the dynamic information associated with at least one of the driver and the vehicle from the monitoring units. Furthermore, the system includes at least one server communicatively coupled to the mobile device for receiving the dynamic information from the mobile device cradle via the mobile device. Moreover, the system includes an EECU coupled to the mobile device cradle via an interface for receiving a signal from the mobile device cradle upon authentication of the driver, where the EECU is configured to start the engine of the vehicle based on the signal.

Other features of the embodiments will be apparent from the accompanying drawings and from the detailed description that follows.

### BRIEF DESCRIPTION OF THE ACCOMPANYING DRAWINGS

FIG. 1 illustrates a block diagram of a vehicle monitoring system using a mobile device cradle for collecting dynamic parameters of a vehicle and a driver of a vehicle, according to one embodiment.

FIG. 2 illustrates an exploded view of the mobile device cradle, according to one embodiment.

The drawings described herein are for illustration purposes only and are not intended to limit the scope of the present disclosure in any way.

### DETAILED DESCRIPTION OF THE EMBODIMENTS OF THE INVENTION

The present invention provides a multi-purpose intelligent cradle for a vehicle. The following description is merely exemplary in nature and is not intended to limit the present disclosure, applications, or uses. It should be understood that throughout the drawings, corresponding reference numerals indicate like or corresponding parts and features.

The terms “intelligent cradle”, “multi-purpose intelligent cradle”, “mobile device cradle” are interchangeably used throughout the document.

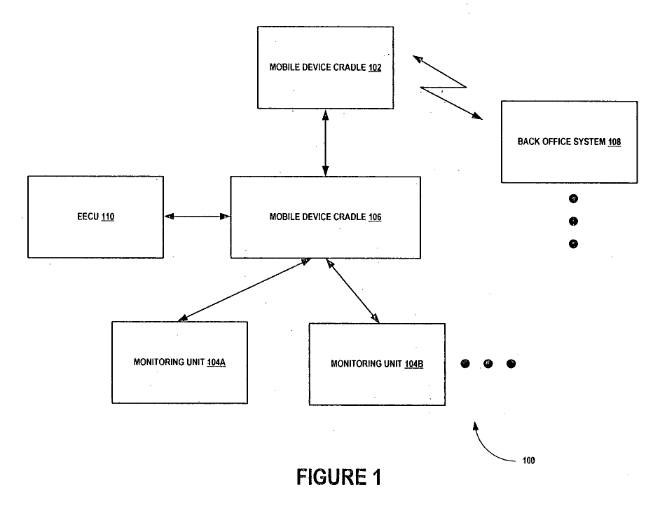

FIG. 1 illustrates a block diagram of a vehicle monitoring system 100 using a mobile device cradle 106 for collecting dynamic parameters of a vehicle and a driver of a vehicle, according to one embodiment. In FIG. 1, the vehicle monitoring system 100 includes a mobile device 102, monitoring units 104A-N, the mobile device cradle 106 coupled to the monitoring units 104A-N, one or more back office systems 108 communicatively coupled to the mobile device cradle 106 via the mobile device 102. Also, the system 100 includes an electronic engine control unit 110 of the vehicle communicatively coupled to the mobile device cradle 106 via an interface.

The mobile device 102 may be a cellular phone, smart phone, personal digital assistants and the like capable of communicating over a wireless network using voice and data communication. The monitoring units 104A-N may include an onboard diagnostic unit, a health monitoring unit, an emission monitoring unit, a sensor unit, a load monitoring unit, and the like. The back office systems 108 may include a road transport back office system, a road tax calculation system, a variable fuel pricing system, an emission monitoring back office system, a location/map storage system, a hospital emergency system, an emergency rescue system, an insurance company back end system, and a parking monitoring back end system.

In an exemplary operation, when a driver inserts his/her mobile device 102 in the mobile device cradle 106, the mobile device cradle 106 recognizes identity of a driver based on the information in the SIM card of the mobile device 102. Accordingly, the mobile device cradle 106 provides a signal to the EECU 110 upon successful authentication of the driver. Thus, the EECU 110 starts the engine of the vehicle when the engine is cranked by the driver. If the driver is not authenticated successfully, then the EECU 110 may not start the engine of the vehicle upon cranking the engine.

In another exemplary operation, the monitoring units 104A-N continuously monitors dynamic information associated with the driver and/or the vehicle. The dynamic information may include speed information, acceleration information, deceleration information, instant fuel consumption information, distance to empty fuel information, vehicle health condition information, vehicular emission information, vehicle geographical location information, time of travel information, continuous running time information, average idling time information, driver information, driver's health condition information, and passenger information. The mobile device cradle 106 coupled to the various monitoring units 104A-N collects the dynamic information associated with the driver and/or the vehicle from the monitoring units 104A-N. The mobile device cradle 106 thus intelligently communicates the dynamic information to the appropriate back office system 108 using the communication capability of the mobile device 102.

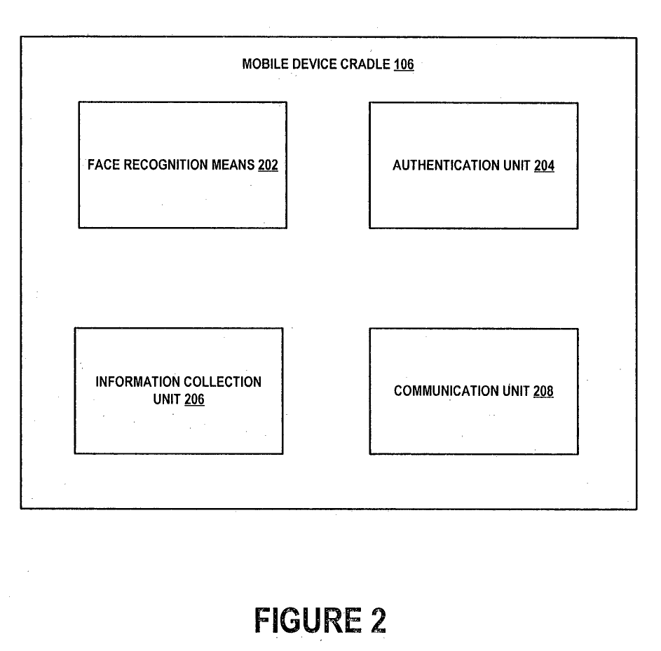

FIG. 2 illustrates an exploded view of the mobile device cradle 106, according to one embodiment. The multi-purpose intelligent cradle 106 includes a body and a base coupled to the body for mounting on to the vehicle. The multipurpose intelligent cradle 106 also includes docking members coupled to the body for receiving the mobile device 102. The multi-purpose intelligent cradle 106 further includes a face recognition means 202 such as a camera mounted on the body for capturing a face of the driver, environmental conditions and/or traffic conditions. In one embodiment, the camera is capable of capturing images in a 360° angle.

Also, the mobile device cradle 106 includes an authentication unit 204 coupled to the EECU 110 which authenticates the driver based on the mobile device received in the docking members and the face of the driver captured by the face recognition means 202 and provides an authentication signal for starting the vehicle to the EECU 110 of the vehicle. Further, the mobile device cradle 106 includes an information collection unit 206 to collect the dynamic information associated with the driver and the vehicle from the monitoring units 104A-N.

Furthermore, the mobile device cradle 106 includes a communication unit 208 which communicates the dynamic information to the back office system(s) 108 via the mobile device 102. The communication unit 208 is also configured to receive instructions from the back office system(s) or server 108 via the mobile device 102 and to provide the instructions received from the respective back office system 108 to the EECU 110 through the interface coupling the mobile device cradle 106 and the EECU 110.

In accordance with the one or more embodiments described above, the multipurpose intelligent cradle 106 is fitted within the vehicle and uses power supply of the vehicle for its functioning. The intelligent cradle 106 has its own internal memory and processing unit for storing various parameters and processing them on need basis. The intelligent cradle 106 includes suitable interfaces to pair with any compatible mobile device 102 for communicating with the back office systems 108. In one example embodiment, the intelligent cradle 106 pairs with a compatible mobile device 102 to authenticating the mobile device 102. The authentication mechanism involves sharing and verifying a code in encrypted format. The intelligent cradle 106 can be provided with a microphone and associated electronics to interpret sound waves received from the mobile device 102. The codes used to authenticate the mobile device 102 are changed in real time. In this case, the authentication takes place by taking into account strength of the sound waves to determine distance of the mobile device 102 from the intelligent cradle 106.

Also, the authentication of the driver can be performed using images captured by the camera 202 once the mobile device 102 is placed in the intelligent cradle 106. The intelligent cradle 106 is capable of storing face images of authorized drivers internally in its face recognition database so that when the mobile device 102 is inserted in the intelligent cradle 106, it can capture the image of the driver and match with the existing images in its memory. If the driver's image captured matches with an image available in its memory, the intelligent cradle 106 authenticates the driver and sends an authentication signal to the EECU 110. The authentication is performed for starting the engine of the vehicle so that only authenticated drivers having valid wireless communication devices are able to drive the vehicle. The intelligent cradle 106 is capable of rotating the camera 202 with an angle of 360 degrees so that it can capture images and videos of internal and external objects on need basis.

For monitoring the vehicle, the intelligent cradle 106 may interface with an OBD unit of the vehicle to, capture various parameters that determines functioning of the vehicle. The intelligent cradle 106 may collect vehicle speed, acceleration, engine speed, engine temperature, etc., from the OBD unit of the vehicle and communicates the information to at least one of the back end servers 108. The intelligent cradle 106 is capable of capturing emission values from the OBD unit of the vehicle and communicating the same to a back office system 108 for computing variable fuel pricing and/or reward points to drivers whose vehicles pollute less. The intelligent cradle 106 also includes a GPS receiver to obtain location information of the vehicle directly from satellite. The intelligent cradle 106 can capture location of the vehicle directly from the satellite and process latitude and longitude for calculating the speed of the vehicle, location etc. and for computing emission values. The intelligent cradle 106 also includes capability to measure acceleration and deceleration of the vehicle using an accelerometer. In addition, the intelligent cradle 106 may uses gyroscopes to measure impact on the vehicle at sharp turns.

The intelligent cradle 106 includes an interface with the EECU 110 of the vehicle so that the intelligent cradle 106 can give instructions to the EECU 110 to alter vehicle characteristics such as top speed, acceleration etc. based on various dynamic parameters such as the location of the vehicle, time of travel etc. For example, the intelligent cradle 106 may obtain location information of the vehicle and if it is within city limit and peak traffic hours, the EECU 110 is instructed to limit upper speed and acceleration to a predefined value. The intelligent cradle 106 is also capable of instructing the EECU 110 to control speed of the vehicle based on processing of the information by the server 108.

The intelligent cradle 106 is also capable of accepting instructions remotely using wireless technologies such as SMS, GPRS, Wi-Fi etc. to instruct the EECU to alter the dynamic information of the vehicle such as speed, acceleration/deceleration rate, start and stop of the vehicle etc.

The mobile device 102 may include a health profile of the driver, such as various health conditions and history of medical services availed by the driver, so that the health profile can be read by the intelligent cradle 106 and provided to the hospital emergency medical teams in case of an emergency. The intelligent cradle 106 is capable of interfacing with a health monitoring unit (HMU) having different health monitoring equipments including but not limited to sphygmomanometer, ECG etc., so that instant health conditions of the driver can be monitored. If there is variation from permissible values, the intelligent cradle 106 can communicate with suitable hospital back office systems 108 and provide the details for getting emergency services to the driver.

The intelligent cradle 106 is also capable of converting the dynamic information collected from the monitoring units 104A-N, generating voice equivalent of the dynamic information and communicating voice back to the respective back office systems 108 using the mobile device 102.

In addition, using the wireless communication device having suitable interfaces with the telecom network operator, the intelligent cradle 106 can find a location from cell identifier or triangulation methods. Further, the intelligent cradle 106 within the vehicle may allow police and road authorities to remotely control the vehicle through an interface between the intelligent cradle 106 and their systems. Using the interface, the police or road authorities can control speed of the vehicle and even instruct the EECU 110 to stop the vehicle if necessary. For example, if a vehicle is polluting above a specified limit, the government authorities can instruct the EECU 110 over the intelligent cradle 106 to reduce the speed and stop the vehicle.

The intelligent cradle 106 also monitors service interval of the vehicle and using the data provided collected from the OBD unit, the intelligent cradle 106 auto dials a nearest service station using the mobile device 102. The intelligent cradle 106 continuously monitors dynamic parameters of the vehicle and passes the dynamic information to suitable entities at the time of a crash. For example, speed and location information can be sent to the traffic police back office system, hospital back office system and insurance back office system at the time of the crash.

The present embodiments have been described with reference to specific example embodiments, it will be evident that various modifications and changes may be made to these embodiments without departing from the broader spirit and scope of the various embodiments. Furthermore, the various devices, modules, selectors, estimators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A mobile device cradle for a vehicle, comprising:
a body;
one or more docking members coupled to the body for receiving a mobile device of a driver of the vehicle;
an information collection unit operable for collecting dynamic information associated with the driver and the vehicle from the mobile device and one or more monitoring units; and
a communication unit operable for communicating the dynamic information to at least one back office system using the mobile device.

2. The cradle of claim 1, further comprising:
a face recognition means mounted on the body of the mobile device cradle and operable for periodically capturing at least one of a face of the driver, environmental conditions and traffic conditions.

3. The cradle of claim 2, further comprising:
an authentication unit coupled to an electronic engine control unit (EECU) of the vehicle and operable for:
authenticating the driver of the vehicle based on the dynamic information collected by the information collection unit and the face of the driver captured by the face recognition means; and
providing an authentication signal for starting the vehicle to the EECU of the vehicle upon successful authentication of the driver.

4. The cradle of claim 1, further comprising:
a base coupled to the body for mounting the mobile device cradle on to the vehicle.

5. The cradle of claim 1, wherein the communication unit is configured to receive instructions for controlling the operation of the vehicle from the at least one back office system via the mobile device.

6. The cradle of claim 5, wherein the communication unit is configured to provide the instructions received from the at least one back office system to the EECU through an interface coupling the mobile device cradle and the EECU.

7. The cradle of claim 1, wherein the dynamic information comprises speed information, acceleration information, deceleration information, instant fuel consumption information, distance to empty fuel information, vehicle health condition information, vehicular emission information, vehicle's geographical location information, time of travel information, continuous running time information, average idling time information, driver information, driver's health condition information, and passenger information.

8. The cradle of claim 2, wherein the face recognition means comprises a camera capable of capturing images in a 360° angle.

9. A system comprising:
a mobile device of a driver of a vehicle;
one or more monitoring units for monitoring dynamic information associated with at least one of the driver and the vehicle;
a mobile device cradle coupled to the one or more monitoring units operable for collecting the dynamic information associated with the driver and the vehicle from the mobile device and the one or more monitoring units; and
at least one server communicatively coupled to the mobile device for receiving the dynamic information from the mobile device cradle via the mobile device.

10. The system of claim 9, further comprising:
an electronic control unit (EECU) coupled to the mobile device cradle via an interface for receiving a signal from the mobile device cradle upon authentication of the driver, wherein the EECU is configured to start the engine of the vehicle based on the signal.

11. The system of claim 10, wherein the mobile device cradle comprises:
a body;
one or more docking members coupled to the body for receiving the mobile device;
an information collection unit for collecting the dynamic information associated with the driver and the vehicle from the mobile device and the one or more monitoring units; and
a communication unit for communicating the dynamic information to the at least one server using the mobile device.

12. The system of claim 11, wherein the mobile device cradle further comprises:
a face recognition means mounted on the body of the mobile device cradle for capturing at least one of a face of the driver, environmental conditions and traffic conditions.

13. The system of claim 12, wherein the mobile device cradle comprises an authentication unit coupled to the EECU operable for:
authenticating the driver based on the dynamic information associated with the driver and the face of the driver captured by the face recognition means; and
providing an authentication signal for starting the vehicle to the EECU of the vehicle upon successful authentication of the driver.

14. (canceled)

15. The system of claim 11, wherein the communication unit is configured to receive instructions for controlling the operation of the vehicle from the at least one server via the mobile device.

16. The system of claim 15, wherein the communication unit is configured to provide the instructions received from the at least one server to the EECU through the interface coupling the mobile device cradle and the EECU.

17. The system of claim 9, wherein the dynamic information comprises speed information, acceleration information, deceleration information, instant fuel consumption information, distance to empty fuel information, vehicle health condition information, vehicular emission information, vehicle geographical location information, time of travel information, continuous running time information, average idling time information, driver information, driver's health condition information, and passenger information.

18. The system of claim 12, wherein the face recognition means comprises a camera capable of capturing images in a 360° angle.

19. The system of claim 9, wherein the at least one server is associated with a back office system selected from the group consisting of a road transport back office system, a road tax calculation system, a variable fuel pricing system, an emission monitoring back office system, a location/map storage system, a hospital emergency system, an emergency rescue system, an insurance company back end system, and a parking monitoring back end system.

20. The system of claim 9, wherein the one or more monitoring units comprises an on board diagnostics unit, emission monitoring unit, sensor unit, load monitoring unit, and health monitoring unit.

21. The system of claim 9, wherein the mobile device comprises a device having wireless capabilities for communicating with the at least one server selected from the group consisting of a cell phone, a smart phone, and a personal digital assistant.
